(19) United States
(12) Patent Application Publication
(10) Pub. No.: US 2020/0339830 A1
(43) Pub. Date: Oct. 29, 2020

(54) INKJET INK AND THREE-DIMENSIONAL MODELING METHOD USING SAME

(71) Applicant: CANON KABUSHIKI KAISHA, Tokyo (JP)

(72) Inventors: Yohei Masada, Tokyo (JP); Takaharu Aotani, Tokyo (JP)

(21) Appl. No.: 16/853,504

(22) Filed: Apr. 20, 2020

(30) Foreign Application Priority Data
Apr. 26, 2019 (JP) 2019-086465

(51) Int. Cl. C09D 11/38; C09D 11/36; B22F 3/105; B22F 1/00

(52) U.S. Cl. CPC C09D 11/38; C09D 11/36; B33Y 10/00; B22F 1/0018; B22F 1/0088; B22F 3/1055

(57) ABSTRACT

An inkjet ink having nickel particles dispersed in water, in which stable dispersion of the nickel particles and stable inkjet ejection are implemented. The inkjet ink includes nickel particles, a dispersant, a nonionic surfactant, and a mixed solvent of water and a water-soluble organic solvent. The inkjet ink contains the dispersant in an amount of 10 parts by mass or more and 100 parts by mass or less with respect to 100 parts by mass of the nickel particles, and contains the water-soluble organic solvent in an amount of 11 parts by mass or more and 100 parts by mass or less with respect to 100 parts by mass of the water.

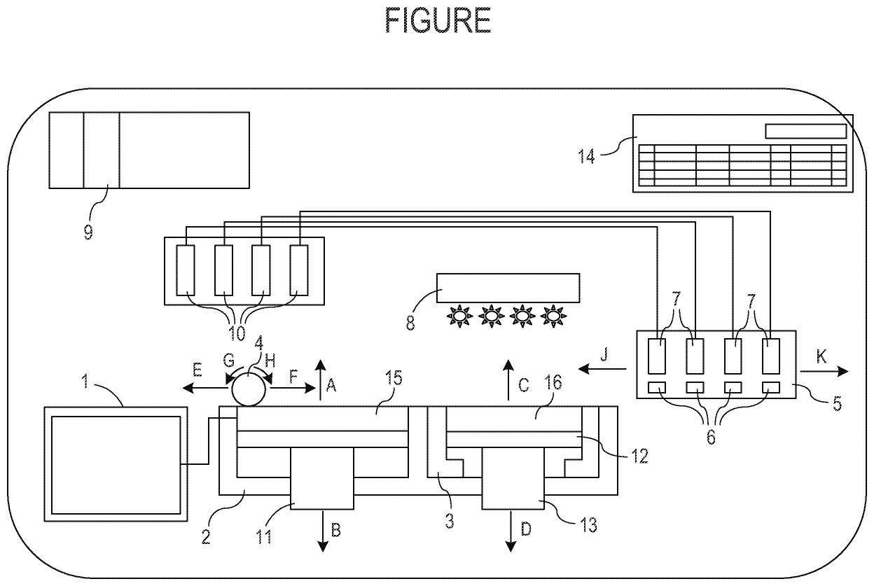

### BACKGROUND OF THE INVENTION

### Field of the Invention

The present disclosure relates to an inkjet ink and a three-dimensional modeling method using the inkjet ink.

### Description of the Related Art

Along with downsizing and thinning of an electronic device, a fine arrangement technology, a thin film forming technology, and a fine joining technology of a metal material have been investigated. For example, in manufacturing of a fine and dense electronic device, the development of a printed electronics manufacturing technology has been advanced. Such technology involves preparing an ink in which metal particles having an average particle diameter of 100 nm or less are dispersed in a solvent and applying the ink to form a fine pattern shape by an inkjet printing method or a screen printing method, to thereby manufacture an electronic device. In addition, there have also been investigated the metal particles serving as a joining agent through use of the characteristics in that when the metal particles are microparticulated, a low-temperature firing function is exhibited, with the result that the metal particles are sintered with each other and simultaneously bonded to a surface of a joining member. Thus, the metal particles have a potential for use in various industrial materials.

As a metal to be used as the metal particles, a large number of investigations have been conducted on silver particles and gold particles from the viewpoint of metal stability, In Japanese Patent Application Laid-Open No. 2005-247905, there has been proposed a metal particle ink using silver particles, gold particles, or palladium particles. In addition, as another conductive material, nickel has also been investigated. In each of Japanese Patent Application Laid-Open No. 2006-28320 and Japanese Patent Application Laid-Open No, 2006-210301, there is disclosed an aqueous metal particle ink having nickel particles dispersed therein. In the case of an ink applied to the inkjet printing method, it is desired that the metal particles have an average dispersed particle diameter of 300 nm or less in order to stably perform printing. Further, a smaller dispersed particle diameter is required in order to ensure dispersion stability at a time of storage.

In addition, as a main solvent to be used in the metal particle ink, water is required from the viewpoint of reducing both a load on a working environment and a load on a global environment.

In actuality, however, there is a technical disadvantage in that, when the microparticulation of the metal particles is advanced, surface energy is increased, with the result that the metal particles are liable to be aggregated. There is a fear in that, as the microparticulation is advanced, an ejection error may be caused by clogging with aggregated particles in an inkjet nozzle. In view of the foregoing, the above-mentioned related-art aqueous metal particle ink may not have sufficient dispersion stability and inkjet suitability. It is known that water to be used as a solvent is liable to oxidize the surface of a metal, and as microparticulation is advanced, the surface area of the metal is further increased, with the result that oxidation is accelerated. The characteristics of the metal may be changed. In particular, in the vicinity of the inkjet nozzle, the metal particles are brought into contact with an external environment. Therefore, the oxidation and fixation of the metal particles are accelerated due to the influence of oxygen in air and drying, and ejection stability may be decreased due to the destabilization of dispersion.

In Japanese Patent Application Laid-Open No. 2005-247905, the oxidation of the metal particles in the vicinity of the inkjet nozzle is suppressed when silver or gold particles are used, but the influence of oxidation may be increased when other metal particles are used. In addition, when the amount of a water-soluble organic solvent contained in an ink solvent is large, and an ionic dispersant is used, a dispersion effect may be reduced, and storage stability and inkjet ejection stability may be decreased.

In each of Japanese Patent Application Laid-Open No, 2006-28320 and Japanese Patent Application Laid-Open No. 2006-210301, the amount of a dispersant with respect to the metal particles is small. Therefore, dispersibility required for inkjet ejection cannot be sufficiently ensured. In particular, when an inkjet head adaptable to a high resolution is used, ejection stability may be decreased.

### SUMMARY OF THE INVENTION

An aspect of the present disclosure is to implement, in an inkjet ink having nickel particles dispersed in water, stable dispersion of the nickel particles and stable inkjet ejection. Another aspect of the present disclosure is to provide a three-dimensional modeling method using the inkjet ink.

According to at least one embodiment of the present disclosure, there is provided an inkjet ink (hereinafter sometimes referred to simply as “ink”) including nickel particles, a dispersant, a nonionic surfactant, and a mixed solvent of water and a water-soluble organic solvent, wherein the inkjet ink contains the dispersant in an amount of 10 parts by mass or more and 100 parts by mass or less with respect to 100 parts by mass of the nickel particles, and wherein the inkjet ink contains the water-soluble organic solvent in an amount of 11 parts by mass or more and 100 parts by mass or less with respect to 100 parts by mass of the water.

According to at least one embodiment of the present disclosure, in the inkjet ink having the nickel particles dispersed in the water, dispersion stability of the nickel particles and inkjet ejection stability can be improved.

Further features of the present disclosure will become apparent from the following description of exemplary embodiments with reference to the attached drawing.

### BRIEF DESCRIPTION OF THE DRAWINGS

The figure is a schematic view of a three-dimensional modeling apparatus to be used in a three-dimensional modeling method according to at least one embodiment of the present disclosure.

### DESCRIPTION OF THE EMBODIMENTS

Now, the present disclosure is described in detail by way of exemplary embodiments. The present disclosure is not limited to the following embodiments, and the following embodiments, which are appropriately changed, modified, and the like based on the ordinary knowledge of a person skilled in the art without departing from the spirit of the present disclosure, are also encompassed within the scope of the present disclosure.

### Inkjet Ink

An inkjet ink according to at least one embodiment of the present disclosure includes nickel particles, a dispersant, a nonionic surfactant, and a mixed solvent of water and a water-soluble organic solvent, and preferably further includes a first additive. In addition, the inkjet ink according to at least one embodiment of the present disclosure contains the dispersant in an amount of 10 parts by mass or more and 100 parts by mass or less with respect to 100 parts by mass of the nickel particles, and contains the water-soluble organic solvent in an amount of 11 parts by mass or more and 100 parts by mass or less with respect to 100 parts by mass of the water.

In the inkjet ink according to at least one embodiment of the present disclosure, an average particle diameter DSO (50% cumulative volume particle diameter) measured by a dynamic light scattering method (hereinafter sometimes referred to as “DLS method”) of the nickel particles is preferably 10 mu or more and 150 nm or less, more preferably 10 nm or more and 100 nm or less. In addition, in the inkjet ink according to at least one embodiment of the present disclosure, an average particle diameter D90 (90% cumulative volume particle diameter) measured by the DLS method of the nickel particles is preferably 250 nm or less. When the D50 is 10 nm or more, the surface area of each of the nickel particles falls within an appropriate range, and hence an oxidation preventing action is retained also in water. When the D50 is 150 nm or less, the specific gravity of each of the nickel particles falls within an appropriate range with respect to the viscosity of the aqueous ink, and hence a dispersion state can be kept. In addition, when the D90 is 250 nm or less, a dispersion state can be kept without any sedimentation at a time of storage.

The inkjet ink according to at least one embodiment of the present disclosure is an aqueous ink in which the nickel particles are dispersed in water, and which is excellent in dispersion stability even though the nickel particles are fine particles, and has high inkjet suitability. Thus, through use of such ink, stable inkjet printing and a three-dimensional modeling method can be provided. The inkjet ink according to at least one embodiment of the present disclosure may be used, for example, under a state of being accommodated in an inkjet cartridge.

Now, the configuration of the inkjet ink according to at least one embodiment of the present disclosure is described. The inkjet ink according to at least one embodiment of the present disclosure contains the nonionic surfactant and the water-soluble organic solvent, and the suitability as an ink can be imparted to the inkjet ink through addition of those components. In addition, the inkjet ink may contain various additives (third additive) and resin particles as required. For example, in the case of the inkjet ink, the viscosity, surface tension, and pH, which are liquid physical properties, may be appropriately adjusted in accordance with an inkjet head to be used through addition of the nonionic surfactant, the water-soluble organic solvent, and the third additive. In addition, when the inkjet ink contains the resin particles, adhesiveness and a binding property to a medium to which the ink is applied, and scratch resistance can be enhanced.

### Nickel Particles

The nickel particles in the inkjet ink according to at least one embodiment of the present disclosure are metal particles in which the proportion of nickel atoms to constituent components of primary particles is more than 50% (atm %). The nickel particles in at least one embodiment of the present disclosure may be synthesized by a generally known method. For example, a gas phase method, such as a chemical vapor deposition method or a physical vapor deposition method, or a liquid phase method, such as a spray pyrolysis method, a laser abrasion method, an ultrasonic method, a sol-gel method, a liquid-phase reduction method, or a solvothermal method, may be used. In order to control the dispersion state in a liquid, it is preferred to use nickel particles obtained by a method involving reducing a metal salt containing a nickel element in a liquid.

The metal salt containing a nickel element is not limited as long as the metal salt contains Ni(II). Examples thereof include nickel chloride, nickel bromide, nickel sulfate, nickel nitrate, nickel carbonate, nickel acetate, nickel formate, nickel carbonyl, and nickel acetylacetonate.

In addition, in order to impart stability, functions, and the like, nickel may be mixed with any other metal salt or any other element than nickel and reduced to obtain an alloy or the like in which the proportion of the nickel element is more than 50% (atm %). Further, the metal particles may be each covered with an oxide, another element, a compound, or the like.

As a reducing agent to be used at a time of reduction, a reducing agent to be generally used for reducing a metal may be used. Examples thereof include sodium borohydride, lithium borohydride, potassium borohydride, sodium hydride, lithium hydride, hydrazine, and ascorbic acid. The concentration of the reducing agent is preferably higher, and is preferably set to 1 mass % or more and a concentration of a saturated solution at room temperature or less.

Through addition of a second additive at a time of reduction of the metal salt containing a nickel element, the shape and the particle diameter of each of the nickel particles to be generated by reduction can be controlled. The reason for this is considered as described below. The second additive adsorbs to the surface of a crystal growing with the reducing agent to inhibit the growth of the crystal, to thereby suppress the primary particle diameter of each of the nickel particles. As the second additive, there are given one kind or two or more kinds of compounds selected from 2-pyrrolidone, N-methylpyrrolidone, N-ethylpyrrolidone, N-methanolpyrrolidone, N-ethanolpyrrolidone, polyvinylpyrrolidone (PVP), polyethylene glycol (PEG), and a fatty acid salt. It is preferred that the second additive be contained in an amount of from 0.1 mass % to 10 mass % based on the total mass of a reaction solution. It is preferred that the mass-average molecular weight of PVP and/or PEG contained as the second additive fall within a range of 1,000 or more and 100,000 or less. In addition, it is preferred that a plurality of PVPs and/or PEGs having different molecular weight distributions be mixed to be added. The second additive is removed by washing after generation of particles.

As a solvent at a time of reduction, deionized water, an alcohol, or a nitrogen-containing compound is mainly used. Examples thereof include methanol, ethanol, propanol, isopropanol, 2-pyrrolidone, and N-methylpyrrolidone. One kind or two or more kinds thereof may be used, and deionized water, an alcohol, and/or a nitrogen-containing compound may be used as a mixture thereof.

The average particle diameter D50 measured by the DLS method of the nickel particles in at least one embodiment of the present disclosure is preferably 10 nm or more and 150 nm or less, more preferably 10 nm or more and 100 nm or less, and the average particle diameter D90 measured by the DLS method thereof is preferably 250 nm or less. When the D50 is 10 nm or more, the surface area of each of the nickel particles falls within an appropriate range, and hence an oxidation preventing action is retained also in water. When the D50 is 150 nm or less, the specific gravity of each of the nickel particles falls within an appropriate range with respect to the viscosity of the aqueous ink, and hence a dispersion state can be kept. In addition, when the D90 is 250 nm or less, a dispersion state can be kept without any sedimentation also at a time of storage.

The inkjet ink according to at least one embodiment of the present disclosure contains the nickel particles in an amount of 0.5 mass % or more and 30 mass % or less, preferably in an amount of 5 mass % or more and 15 mass % or less. When the amount of the nickel particles is less than 0.5 mass %, an effect exhibited by the incorporation of the nickel particles is not obtained. When the amount of the nickel particles is more than 30 mass %, the viscosity of the ink is excessively increased, with the result that ejection by an inkjet system becomes difficult.

### Dispersant

Examples of the dispersant include ionic surfactants, such as a fatty acid, an alkyl sulfonic acid, an alkyl benzene sulfonic acid, an alkyl sulfuric acid, an alkylamine, an alkyl trimethyl, an alkylcarboxybetaine, and salts thereof, water-soluble polymers, such as a polycarboxylic acid, polystyrenesulfonic acid, a polyurethane-based polymer, a polyalkylenepolyamine, polyethyleneimine, carboxymethyl cellulose, and polyvinylpyrrolidone, and salts thereof. Of those, a fatty acid, an alkyl benzene sulfonic acid, an alkyl sulfuric acid, a polycarboxylic acid, and salts thereof are each preferably used as the dispersant.

The fatty acid preferably includes at least any one of lauric acid, myristic acid, palmitic acid, stearic acid, myristoleic acid, palmitoleic acid, sapienic acid, oleic acid, elaidic acid, vaccenic acid, gadoleic acid, eicosenoic acid, erucic acid, nervonic acid, and salts thereof.

Examples of the polycarboxylic acid include a polymer containing at least a monomer selected from acrylic acid, methacrylic acid, and maleic anhydride, and salts thereof. The examples also include a polymer containing the above-mentioned monomer and further containing a monomer such as an acrylic acid ester, a methacrylic acid ester, a maleic acid ester, styrene, styrenesulfonic acid, or an olefin, and salts thereof. The polycarboxylic acid preferably has a mass-average molecular weight falling within a range of 1,000 or more and 50,000 or less. When the mass-average molecular weight is 1,000 or more, the dispersion stability of a metal is sufficient. When the mass-average molecular weight is 50,000 or less, the viscosity is appropriate, and dispersion treatment can be sufficiently performed.

It is preferred that a counter ion of an ionic substance out of those described above be a sodium ion, a potassium ion, an ammonium ion, or an ion which is formed when a compound represented by the following general formula (A) is protonated. It is preferred that such organic amine-based counter ion be used because, after the ink or the like prepared through use of such ion is used for pattern drawing, the ink or the like can be removed by heating and sintering, and hence the performance as a metal can be further significantly expressed.

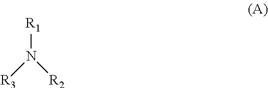

In the general formula (1), R₁, R₂, and R₃ each independently represent any one of —H, —CH₃, —CH₂CH₃, —CH₂CH₂CH₃, —CH₂CH₂CH₂CH₃, —CH₂OH, —CH₂CH₂OH, and —CH₂CH₂CH₂OH.

The amount of the dispersant is 10 parts by mass or more and 300 parts by mass or less, preferably 10 parts by mass or more and 100 parts by mass or less with respect to 100 parts by mass of the nickel particles. When the amount of the dispersant with respect to 100 parts by mass of the nickel particles is less than 10 parts by mass, the dispersion of the nickel particles is insufficient, and there is a risk in that coarse particles may remain. When the amount of the dispersant with respect to 100 parts by mass of the nickel particles is more than 300 parts by mass, the dispersion of the nickel particles is unstable. In addition, the inkjet ink according to at least one embodiment of the present disclosure contains the dispersant for the nickel particles in an amount of 0.05 mass % or more and 30 mass % or less, When the amount of the dispersant is less than 0.05 mass %, the dispersion of the nickel particles is insufficient. When the amount of the dispersant is more than 30 mass %, the viscosity of the ink is excessively increased, with the result that ejection by an inkjet system becomes difficult.

### Nonionic Surfactant

As the nonionic surfactant, any known nonionic surfactants may each be used. Of those, an ethylene oxide adduct such as acetylene glycol or the like, a fluorine-based surfactant, and a silicon-based surfactant are preferred. Of those, an ethylene oxide adduct such as acetylene glycol or the like is more preferably used. In particular, a compound represented by the following general formula (1) is preferably used.

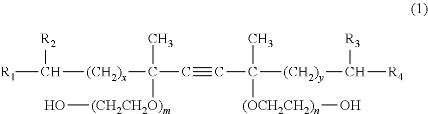

In the general formula (1), R₁ to R₄ each independently represent an alkyl group having 1 to 3 carbon atoms, “x” and “y” each independently represent from 1 to 5, and “m” “n” represents from 0 to 20.

Examples of the ethylene oxide adduct such as acetylene glycol or the like include Surfynol 104, 440, and 465 (each of which is manufactured by Air Products Limited), ACETYLENOL E40, E60, and E100 (each of which is manufactured by Kawaken Fine Chemicals Co., Ltd), and Dynol 604, 607, 800, and 810 (each of which is manufactured by Air Products Limited).

The content of the nonionic surfactant is preferably 0.1 mass % or more and 3.0 mass % or less, more preferably 0.2 mass % or more and 1.5 mass % or less based on the total mass of the ink. When the content of the nonionic surfactant is 0.1 mass % or more, a sufficiently large dot diameter is obtained, and a drawing portion can be satisfactorily filled. In addition, when the content of the nonionic surfactant is 3.0 mass % or less, permeation in a recording medium becomes thin, and hence the nickel particles can be prevented from deeply permeating the recording medium to locally decrease a metal concentration.

Those nonionic surfactants may be added in combination thereof. In particular, through combination of the ethylene oxide adduct such as acetylene glycol or the like and the fluorine-based surfactant or the silicon-based surfactant, an effect of increasing wettability to the medium to which the ink is applied is obtained.

### Mixed Solvent

The mixed solvent contains water and a water-soluble organic solvent. In at least one embodiment of the present disclosure, the “water-soluble organic solvent” means an “organic solvent having a solubility in water at 20° C. of 200 g/L or more”.

It is preferred that, as the water, deionized water (ion-exchanged water) be used. It is preferred that the content of the water be 30 mass % or more and 90 mass % or less based on the total mass of the ink.

As the water-soluble organic solvent, any known solvents that can be used for an ink may each be used. Examples thereof include alcohols, glycols, alkylene glycols, polyethylene glycols, nitrogen-containing compounds, and sulfur-containing compounds. The water-soluble organic solvent preferably contains at least any one water-soluble organic solvent selected from glycerin, diglycerin, ethylene glycol, diethylene glycol, triethylene glycol, tetraethylene glycol, propylene, glycol, 2-pynolidone, N-methylpyrrolidone, polyethylene glycol having a molecular weight of 800 or less, 1,3-propanediol, and 1,4-butanediol. Through use of the above-mentioned solvents, the storage stability and the ejection stability in an inkjet head can be improved. Those water-soluble organic solvents may be used alone or in combination thereof as required.

The content of the water-soluble organic solvent in the ink is 11 parts by mass or more and 100 parts by mass or less, preferably 15 parts by mass or more and 80 parts by mass or less with respect to 100 parts by mass of the water. When the content of the water-soluble organic solvent is less than 11 parts by mass with respect to 100 parts by mass of the water, evaporation of the water is excessively increased in the vicinity of the inkjet nozzle, and the ejection stability may be decreased due to an increase in viscosity and fixation of a solid content. In addition, when the content of the water-soluble organic solvent is more than 100 parts by mass with respect to 100 parts by mass of the water, an effect exhibited by the dispersant adapted to the dispersion in water is decreased, and the storage stability may be decreased.

### First Additive

It is preferred that the inkjet ink according to at least one embodiment of the present disclosure contain, as the first additive, at least any one of acetic acid, glycine, aspartic acid, glutamic acid, citric acid, ethylenediaminetetraacetic acid, oxalic acid, and salts thereof. When the nickel particles are subjected to dispersion treatment through addition of the first additive, the nickel particles are more easily microparticulated, with the result that the storage stability of the inkjet ink and the inkjet ejection stability can be enhanced. The reason for this is considered as described below. A carboxyl group of the first additive acts on a metal to increase a repulsive force, to thereby exhibit an effect of loosening an aggregated portion between the nickel particles. It is preferred that the amount of the first additive be 1 part by mass or more and 50 parts by mass or less with respect to 100 parts by mass of the nickel particles.

### Resin Particles

The inkjet ink according to at least one embodiment of the present disclosure may contain resin particles as required. In at least one embodiment of the present disclosure, the “resin particles” mean a resin present in a solvent so as to be dispersed under a state of having a particle diameter. The average particle diameter D50 measured by the DLS method of the resin particles is preferably 1 nm or more and 200 nm or less, more preferably 5 nm or more and 100 nm or less. It is preferred that the content of the resin particles be 0.1 mass % or more and 10.0 mass % or less based on the total mass of the ink. When the content of the resin particles is 0.1 mass % or more, an effect of improving adhesiveness and a binding property to the medium to which the ink is applied, scratch resistance, and the like is sufficiently obtained. In addition, when the content of the resin particles is 10.0 mass % or less, the inkjet ejection stability and the like are sufficiently obtained. As the kind of the resin particles, for example, polyacrylic resin particles and polyurethane-based resin particles may be preferably used.

### Other Components

The inkjet ink according to at least one embodiment of the present disclosure may contain, as the third additive, a surfactant other than the above-mentioned surfactants, a pH adjuster, a rust inhibitor, an antiseptic agent, a fungicide, an antioxidant, a reduction inhibitor, an evaporation accelerator, a chelating agent, and the like as required. As the antioxidant, for example, acetyl tocopherol, uric acid, gallic acid, glutathione, glycylglycine, and cysteine hydrochloride are preferably used. As the pH adjuster, amine compounds having buffering capacity are each preferably used, and of those, N-butyldiethanolamine is preferably used.

### Method of Producing Inkjet Ink

Next, a method of producing the inkjet ink according to at least one embodiment of the present disclosure is described by taking an example, but the present disclosure is not limited to such method.

### Solution Preparation Step

First, the above-mentioned metal salt containing a nickel element is thoroughly dissolved at a desired molar ratio in deionized water and/or an alcohol, 2-pyrrolidone, or N-methylpyrrolidone to obtain a raw material solution A. It is preferred that the concentration of the metal salt containing a nickel element be set to 0.1 mass % or more and 30 mass % or less, Further, a reducing agent is thoroughly dissolved in deionized water and/or an alcohol in another vessel to obtain a reducing agent solution B. It is preferred that the amount of the reducing agent be set to 1 time or more and 20 times or less in terms of molar concentration with respect to the total of the metal salt containing a nickel element to be used.

In this case, the second additive, such as polyvinylpyrrolidone, may be added to any of the raw material solution A and the reducing agent solution B. It is desired that the reducing agent solution B be a high-concentration solution of the reducing agent, and hence it is preferred that the second additive be added to the raw material solution A.

### Reduction Step

When reduction is performed, in order to suppress the oxidation reaction of the nickel particles to be precipitated, it is desired that the reduction be performed under an inert gas atmosphere. Examples of the inert gas include inert gases such as nitrogen and argon. The raw material solution A is heated under stirring at preferably 30° C. or more and 70° C. or less in a water bath, and the reducing agent solution B is dropped onto the raw material solution A at a rate of preferably 0.05 mL/sec or more and 5M mL/sec or less. In addition, in the case of using hydrazine or the like as the reducing agent, a complex salt of the metal salt and hydrazine or the like is formed, and after that, a mother liquid dissolved with an alkali is heated, to thereby cause reduction to proceed. It is preferred that the reduction be performed for such reaction time that a suspension solution can be sufficiently obtained.

### Washing Step

The suspension solution in which reduction is completed is washed with deionized water. As a washing method, any method of decantation, centrifugation, ultrafiltration, and the like may be used. It is preferred that washing be performed until the concentration of the reducing agent or constituent elements of the reducing agent contained in the removed solution reaches 100 ppm or less. For example, in the case of using NaBH₄ as the reducing agent, it is preferred that washing be performed until the concentration of Na⁺ in the suspension solution reaches 100 ppm or less. After washing, a high-concentration nickel particle paste is obtained.

### Dispersion Step for Nickel Particles

The dispersant, the first additive, and the water-soluble organic solvent are, added to the obtained nickel particle paste, and the mixture is sufficiently stirred, followed by dispersion, to obtain a nickel particle water dispersion. Dispersion is performed by a method such as ultrasonic stirring, an ultrasonic homogenizer, a jet mill, a bead mill, a rotor-stator type homogenizer, or a nanomizer, or a combination of these methods. There is no particular limitation on the dispersion conditions. Although varied depending on an apparatus to be actually used, the dispersion conditions may be appropriately set so that a uniform dispersion liquid is formed in accordance with treatment amounts, such as the kind and concentration of the nickel particles to be treated, and the kind and concentration of the dispersant. In addition, after the dispersion, an excessive dispersant may be removed by washing.

### Ink Preparation Step

The nonionic surfactant is added to the obtained nickel particle water dispersion, and the mixture is stirred, followed by being caused to pass through a filter as required, to obtain an inkjet ink. When the water-soluble organic solvent is not added in the dispersion step for nickel particles, the water-soluble organic solvent may be added in the ink preparation step.

### Three-dimensional Modeling Method

The three-dimensional modeling method according to at least one embodiment of the present disclosure has a feature of using the above-mentioned ink according to at least one embodiment of the present disclosure, and preferably includes the following steps (1) to (4).

Step (1): Forming a metal powder layer

Step (2): Applying an ink to a desired region (modeling region) of the metal powder layer based on slice data on an object to be modeled which has been acquired in advance

Step (3): Heating the metal powder layer to a temperature at which nickel particles contained in the ink are sintered or melted to fix metal powder in the modeling region with the nickel particles, to thereby solidify the metal powder

Step (4): Removing the metal powder from a region other than the modeling region

Through the steps (1) to (4), a sheet-shaped (or plate-shaped) modeled article having a thickness corresponding to one metal powder layer can be formed. When the steps (1) to (4) are repeated, layers can be laminated one after another to obtain a three-dimensional modeled article. In addition, a three-dimensional modeled article having an overhang can also be obtained by performing the step (4) after repeating the steps (1) to step (3). Further, when the steps (3) and (4) are performed after a laminate is formed by repeating the steps (1) and (2) a plurality of times, a three-dimensional modeled article having an overhang can be formed in one heating step of collectively heating the metal powder layers laminated by repeating the steps (1) and (2). Each step is described in detail below.

It is assumed that, before modeling is started, slice data for forming each layer is generated from three-dimensional shape data on an object to be modeled by a modeling apparatus or an external apparatus (for example, a personal computer). As the three-dimensional shape data, data created by a three-dimensional CAD, a three-dimensional modeler, a three-dimensional scanner, or the like can be used, and for example, an STL file or the like can be preferably utilized. The slice data is data which is obtained by slicing a three-dimensional shape of the object to be modeled at predetermined intervals (thickness), and includes information, such as the shape of a cross-section, the thickness of a layer, and the arrangement of materials. The thickness of the layer influences modeling accuracy, and hence it is appropriate that the thickness of the layer be determined in accordance with the modeling accuracy to be required and the particle diameter of each particle to be used for modeling.

### Step (1)

In the step (1), a metal powder layer is formed based on the slice data on an object to be modeled. As used herein, an aggregate of a plurality of metal powder particles is referred to as “metal powder”, an object obtained by forming the plurality of metal powder particles into a layer form (sheet shape) is referred to as “metal powder layer”, and an object obtained by laminating a plurality of metal powder layers is referred to as “laminate”. In the stage of this step, the metal powder particles forming the metal powder layer are not fixed, but the form of the metal powder layer is held with an adhesion force acting between the metal powder particles.

As a metal that may be used as the metal powder particles, there are given, for example, copper, tin, lead, gold, silver, platinum, palladium, iridium, titanium, tantalum, and iron. In addition, a metal alloy, such as a stainless-steel alloy, a titanium alloy, a cobalt alloy, an aluminum alloy, a magnesium alloy, an iron alloy, a nickel alloy, a chromium alloy, a silicon alloy, or a zirconium alloy, may also be used. In addition, for example, carbon steel obtained by adding a non-metal element, such as carbon, to a metal is also used.

For example, as disclosed in Japanese Patent Application Laid-Open No. H08-281807, the metal powder layer may be formed through use of a container opened upward, a vertically movable support installed in the container, and a material supply device including a wiper. Specifically, an upper surface of the support is adjusted to a position at which the upper surface is positioned below an upper edge of the container by the thickness of one layer, and a material is supplied to a flat plate by the material supply device. After that, the material is flattened with the wiper, to thereby form a metal powder layer corresponding to one layer. Alternatively, a metal powder layer having a desired thickness may be formed by supplying metal powder to a flat surface (stage or surface of a modeled article during manufacturing) and making the surface of the metal powder uniform with a layer thickness regulating unit (for example, a blade or a roller). Further, the metal powder layer may be pressurized with a pressurizing unit (for example, a pressure roller or a pressurizing plate). Through pressurization, the number of contact points between the metal powder particles is increased, with the result that defects of the modeled article are less liable to be formed. In addition, when the metal powder particles are densely present in the metal powder layer, the movement of the metal powder particles (disintegration of the form of the metal powder layer) during treatments of the subsequent steps (2) and (3) is suppressed, and a modeled article having high shape accuracy can be manufactured.

### Step (2)

In the step (2), an ink containing metal particles, that is, the inkjet ink according to at least one embodiment of the present disclosure is applied to a modeling region of the metal powder layer by a liquid applying device based on the slice data on the object to be modeled. The “modeling region” as used herein refers to a region corresponding to a cross section of the object to be modeled (that is, a portion to be taken out as a modeled article by solidifying the metal powder particles in the metal powder layer). A region other than the modeling region (that is, a portion in which the metal powder is to be removed in the step (4)) is referred to as “non-modeling region”.

The metal particles contained in the inkjet ink are particles that can be sintered at least at a low temperature and/or in a short period of time as compared to the metal powder particles forming the metal powder layer. In other words, the kind of a metal of the metal powder particles is selected so that such heating conditions (temperature, time, etc.) that, when powder containing both the metal powder particles and the metal particles is heated, the metal powder particles are not sintered with each other, and the nickel particles are sintered with each other can be set, The “sintering” as used herein refers to treatment involving heating the metal powder particles at a temperature equal to or lower than the melting point thereof under a state in which the nickel particles are brought into contact with each other and fixing (bonding) the nickel particles to each other. The phrase “metal powder particles are not sintered with each other” as used herein encompasses the state in which the metal powder particles are not directly fixed to each other and the case in which, even when the metal powder particles are directly fixed to each other, a boundary portion between the metal powder particles can be clearly observed, and a fixing force is weak.

It is preferred that a step of drying the ink be provided between the steps (2) and (3). When the step (3) is performed after the steps (1) and (2) are repeated a plurality of times, the step of drying the ink is preferably performed after the step (2) for each layer. The ink that is gradually condensed as drying proceeds is concentrated at a grain boundary between the metal powder particles due to the surface tension thereof. The nickel particles in the ink are selectively concentrated at the grain boundary between the metal powder particles along with the movement of the ink and are aggregated. As a result of the drying step, nanoparticles are accumulated at the grain boundary between the metal powder particles, and thus, the metal powder particles can be efficiently and strongly fixed at a time of sintering of the nickel particles described later. When the ink is dried, it is preferred that the drying conditions, such as an optimum temperature and time, be selected in accordance with the concentration, amount, and the like of the ink.

As the liquid applying device to be used for applying the ink, any device may be used as long as the device can apply the ink in a desired amount to a desired position. From the viewpoint that a liquid amount and an arrangement position can be accurately controlled, an inkjet device can be preferably utilized.

### Step (3)

In the step (3), the metal powder layer is heated to a temperature at which the nickel particles contained in the ink are sintered or melted, to thereby fix the metal powder particles in the modeling region with each other through intermediation of the nickel particles. It is preferred that the heating temperature be equal to or higher than a temperature at which the nickel particles are sintered or melted and be lower than a temperature at which the metal powder is sintered. The step (3) may be performed for each metal powder layer, or may be performed after a plurality of metal powder layers are laminated by repeating the steps (1) and (2). The latter is preferred in consideration of heating efficiency.

The atmosphere during heating may be arbitrarily determined in accordance with the kind of a material. For example, it is preferred that the metal powder layer be heated under an atmosphere in which the amount of oxygen is small, such as an inert gas atmosphere of Ar, N₂, or the like, a hydrogen gas atmosphere, or a vacuum atmosphere, because the oxidation of a metal during sintering can be suppressed.

### Step (4)

In the step (4), the metal powder in the region other than the modeling region is removed from the laminate obtained in the step (3) to obtain a modeled article. As a method of removing unnecessary metal powder from the laminate, any method including known methods may be used. For example, there are given washing, air blowing, suction, and vibration. The metal powder particles in the region other than the modeling region are not fixed, or even when fixed, the metal powder particles in the region other than the modeling region are weakly fixed as compared to those in the modeling region. Therefore, it is significantly easy to remove the metal powder particles in the region other than the modeling region. In addition, the removed metal powder may also be recovered to be reused as a modeling material.

The steps (1) to (4) are described merely for illustrating basic steps of the modeling method according to at least one embodiment of the present disclosure, and the scope of the present disclosure is not limited to the above-mentioned contents. Specific treatment contents in the above-mentioned steps may be appropriately changed, and a step other than the above-mentioned steps may be added. For example, the density of a modeled article can be increased by heating, after the step (4), the modeled article at a temperature higher than the heating temperature in the step (3), preferably at a temperature equal to or higher than the temperature at which the metal powder is melted or sintered. In this case, the modeled article may be heated under conditions (heating temperature, heating time, etc.) for sintering the metal powder particles. The characteristics of the modeled article can be enhanced, and the strength thereof can be further increased by sintering the metal powder particles with each other.

### Three-dimensional Modeling Apparatus

An apparatus for performing the three-dimensional modeling method according to at least one embodiment of the present disclosure is described with reference to the drawing. The relative arrangement of constituent elements of the apparatus, the shape of the apparatus, and the like are described merely for an illustrative purpose, and the present disclosure is not limited thereto.

A FIGURE is a sectional view of an overall configuration of a three-dimensional modeling apparatus applicable to the present disclosure. The entire apparatus includes: a metal powder tank 1; a metal powder supply bath 2; a modeling bath 3; a roller 4; an ink ejection unit 5 including an ink ejection head 6 and an ink sub-tank 7; a heater unit 8; a control unit 9; an ink tank 10; a metal powder supply stage 11; a modeling bath bottom plate 12; a modeling stage 13; and an operation unit 14, and is configured to form a laminate 16. Those constituent elements are arranged in a housing of the apparatus.

The control unit 9 includes a control portion including a controller, a user interface, and various I/O interfaces, and is configured to perform various controls of the entire apparatus.

The metal powder tank 1 includes a metal powder cartridge (not shown). A user inserts the metal powder cartridge into the main body of the three-dimensional modeling apparatus from the front thereof, to thereby mount the metal powder cartridge therein. Metal powder in the mounted metal powder cartridge is fed from the metal powder tank 1 to the metal powder supply bath 2 and stored therein as supply metal powder 15. The supply metal powder 15 is raised by moving the metal powder supply stage 11 in an A-direction, and the metal powder corresponding to the raised height is transferred to the surface of the laminate 16 by moving the roller 4 in an F-direction. The roller 4 includes a moving mechanism (not shown) capable of moving in an E-direction and the F-direction, and a rotary mechanism (not shown) capable of rotating in any one or both of a G-direction and an H-direction. In addition, in metal powder supply, the metal powder supplied to the laminate 16 may be smoothened by moving the roller 4 in the E-direction after the roller 4 is moved in the E-direction to pass by the laminate 16. At a time of metal powder supply, the roller 4 may be moved while being rotated in the G-direction or the H-direction.

The ink ejection unit 5 is arranged above the modeling bath 3. The ink ejection unit 5 includes a moving mechanism (not shown) capable of moving in a J-direction and a K-direction, and the ink ejection heads 6 that are independently formed so as to correspond to a plurality of inks are held along a movement direction of the ink ejection unit 5. The inks are ejected from the ink ejection heads 6 in synchronization with the movement of the ink ejection unit 5 to be applied onto the laminate 16. In addition, at a time of application of the ink, the ink ejection heads 6 may be moved in both or any one of the J-direction and the K-direction.

The ink tanks 10 are configured to independently store various kinds of inks. The kinds of inks may be overlapped with each other. The inks are supplied through tubes from the ink tanks 10 to the ink sub-tanks 7 provided so as to correspond to the respective inks, and the inks are supplied through tubes from the ink sub-tanks 7 to the respective ink ejection heads 6. In the ink ejection heads 6, line heads for the respective inks are arranged along a movement direction at a time of drive of the ink ejection unit 5. The line heads for the respective inks may be formed of a single nozzle tip without any seam or may be formed of divided nozzle tips arranged in a row or arranged regularly, for example, in a staggered manner. As an inkjet system of ejecting the ink from the nozzle, a system using heating elements, a system using piezoelectric elements, a system using electrostatic elements, a system using MEMS elements, and the like may be adopted. The ink is ejected from the nozzle of each head based on data on a region to which the ink is applied, and the timing of ejection is determined by an output signal of an encoder for movement (not shown) of the ink ejection unit 5.

The laminate 16 formed of a plurality of metal powder layers having the ink applied thereto is heated by the heater unit 8. After heating, the laminate 16 is lowered in a D-direction in accordance with a lamination thickness. Heating and lowering may be performed in a reversed order. When modeling is finished, and modeling of another laminate 16 is started, the modeling stage 13 is moved in a D-direction to enable the modeling bath 3 to be replaced. In addition, the metal powder supply stage 11 is lowered in a B-direction to refill the supply metal powder 15.

The operation unit 14 is a unit configured to allow an operator to perform operation and confirmation in order to confirm the modeling situation for each order regarding whether the laminate 16 is being modeled or modeling thereof is finished or to confirm the apparatus state, such as the remaining amount of the metal powder or the remaining amount of the ink. In addition, the operation unit 14 is a unit configured to allow the operator to perform operation and confirmation in order to perform apparatus maintenance, such as roller cleaning or ink ejection head cleaning.

### EXAMPLES

The present disclosure is described in more detail below by way of Examples and Comparative Examples. The present disclosure is by no means limited to Examples below without departing from the gist of the present disclosure. In the following description, “part(s)” represents part(s) by mass.

### Preparation of Nickel Particle

### Nickel Particles 1

83 Parts of nickel chloride hexahydrate (manufactured by Kishida Chemical Co., Ltd.) was loaded into a vessel. 20 Parts of polyvinylpyrrolidone K-15 (Mw: 10,000, manufactured by Kishida Chemical Co., Ltd.) and 20 parts of polyvinylpyrrolidone K-30 (Mw: 30,000, manufactured by Kishida Chemical Co., Ltd.) each serving as a second additive, and 500 parts of ethanol and 250 parts of deionized water each serving as a solvent were added to the nickel chloride hexahydrate to dissolve the nickel chloride hexahydrate, to thereby prepare a raw material solution A. Then, 25 parts of sodium borohydride (manufactured by Kishida Chemical Co., Ltd.) serving as a reducing agent was added to 50 parts of deionized water to be dissolved therein, to thereby prepare a reducing agent solution B. The deionized water was used after being subjected to gas purging through nitrogen gas bubbling for 30 minutes or more.

The raw material solution A was heated to 50° C. while being stirred at 1,500 rpm, and then the reducing agent solution B was dropped onto the raw material solution A at a rate of 0.1 g/sec. Immediately after the addition of the reducing agent solution B, the resultant became a black suspension solution, and nickel particles were generated. After that, the nickel particles were sufficiently washed with deionized water and ethanol, and the washing was finished when the concentration of sodium ions in a washing liquid reached 10 ppm or less, to thereby obtain a nickel particle paste. The concentration of the nickel particles in the nickel particle paste was calculated by thermal analysis through TG-DTA, and pure water was added thereto so that the concentration of the nickel particles reached 50 mass %, to thereby prepare nickel particles 1.

### Nickel Particles 2

32.3 Parts of nickel chloride hexahydrate (manufactured by Kishida Chemical Co., Ltd.) was dissolved in 67.7 parts of pure water, and 100 parts of a hydrazine monohydrate aqueous solution having a concentration of 80 mass % was added thereto, followed by stirring, to thereby obtain a nickel hydrazine complex salt. 100 Parts of a sodium hydroxide aqueous solution having a concentration of 29 mass % was added to the obtained complex salt, followed by stirring, to thereby obtain a nickel hydrazine complex aqueous solution. Further, an aqueous solution obtained by dissolving 20 parts of polyvinylpyrrolidone K-15 (Mw: 10,000, manufactured by Kishida Chemical Co., Ltd.) in 80 parts of pure water was mixed with the obtained nickel hydrazine complex aqueous solution, to thereby obtain a precursor solution. The obtained precursor solution was increased in temperature to 50° C. while being stirred, and was held for 60 minutes to obtain a black suspension solution, and nickel particles were generated. After that, the nickel particles were sufficiently washed with deionized water and ethanol, and the washing was finished when the concentration of sodium ions in a washing liquid reached 10 ppm or less, to thereby obtain a nickel particle paste. The concentration of the nickel particles in the nickel particle paste was calculated by thermal analysis through TG-DTA, and pure water was added thereto so that the concentration of the nickel particles reached 50 mass %, to thereby prepare nickel particles 2.

### Nickel Particles 3

Nickel particles 3 were obtained by the same method as the preparation method for the nickel particles 2. except that the solvent for adjusting the concentration of the nickel particles to 50 mass % was changed from the pure water to diethylene glycol monobutyl ether.

### Examples 1 to 2.0 and Comparative Examples 1 to 5

A dispersant, an additive, a water-soluble organic solvent, and deionized water shown in Tables 1 to 3 were added to each of the obtained nickel particles 1 to 3 in amounts shown in Tables 1 to 3 including the water or the water-soluble organic solvent contained in each of the nickel particles 1 to 3, and the mixture was stirred at room temperature for 30 minutes. After that, the resultant was dispersed with a homogenizer T-25 (manufactured by IKA) at 10,000 rpm for 8 hours to obtain a nickel particle water dispersion. After that, a nonionic surfactant shown in Tables 1 to 3 was added thereto in an amount shown in Tables 1 to 3. The resultant was stirred for 1 hour and caused to pass through an AP filter (manufactured by Millipore Corporation), to thereby produce an ink or inkjet ink of each of Examples 1 to 20 and Comparative Examples 1 to 5.

The average particle diameters D50 and D90 of the nickel particles in the inkjet ink of each of Examples 1 to 20 and Comparative Examples 1 to 5, the dispersion stability and the inkjet ejection stability of the inkjet ink were evaluated by the following methods. The results are shown in Tables 1 to 3. In addition, substances shown in Tables 1 to 3 are as described below, and all the numerical values are represented by part(s) by mass.

EDTA⋅2NH₄: dihydrogen diammonium ethylenediaminetetraacetate
Acetylene glycol E-100: acetylene glycol EO adduct (manufactured by Kawaken Fine Chemicals Co., Ltd.)
Ammonium polyacrylate: ammonium polyacrylate having a Mw of 6,000
Ammonium salt of acrylic acid/maleic acid copolymer: ammonium salt of acrylic acid/maleic acid copolymer having a Mw of 10,000
Ammonium salt of acrylic acid/methyl methacrylate: ammonium salt of acrylic acid/methyl methacrylate having a Mw of 8,000
Ammonium salt of polyacrylic-styrene: ammonium salt of polyaciylic-styrene having a Mw of 15,000
ISOBAM 600: ammonia neutralized product of an isobutylene-maleic anhydride copolymer having a Mw of from 5,500 to 6,000: (manufactured by Kuraray Co., Ltd.)
ISOBAM 110: ammonia neutralized product of an isobutylene-maleic anhydride copolymer having a Mw of from 160,000 to 170,000: (manufactured by Kuraray Co., Ltd.)

### Physical Property Measurement Method and Evaluation Method

### Average Particle Diameters D50 and D90 of Nickel Particles

Measurement for 120 seconds was performed three times through use of a particle diameter measurement apparatus Nanotrac 150 (manufactured by Microtrac MRB) by a DLS method, to thereby determine an average particle diameter D50 (50% cumulative volume particle diameter) and an average particle diameter D90 (90% cumulative volume particle diameter) of the nickel particles.

### Dispersion Stability Evaluation

The produced ink was allowed to stand still at 25° C. for 7 days and evaluated for stability based on the following criteria.

A: A change rate of the average particle diameter D50 is 10% or less, and no sediment is observed.

B: A change rate of the average particle diameter D50 is 10% or less, and a small amount of sediment is observed but is dispersed with stirring.

C: A change rate of the average particle diameter D50 is 10% or more, or sediment is observed and is not dispersed even with stirring.

### Inkjet Ejection Stability Evaluation

The produced ink was filled into an inkjet head KJ4B (manufactured by Kyocera Corporation), and ejection from the inkjet head was checked at a drive frequency of 30 kHz. 1,000 liquid droplets were ejected per nozzle, and an ejection amount was calculated based on the weight of a recovered liquid. After that, 5×10⁶ liquid droplets were ejected per nozzle in a sequence in which ejection was performed at 30 kHz for 1 sec and stopped for 1 sec. After that, an ejection amount was calculated again, and the stability was evaluated based on the following criteria.

A: A change rate of the ejection amount is 10% or less.

B: A change rate of the ejection amount is 10% or more, but becomes 10% or less through a recovery operation.

C: A change rate of the ejection amount is 10% or more even when the recovery operation is performed.

TABLE 1

| | | Examples | | | | | | | | | |
|---|---|---|---|---|---|---|---|---|---|---|---|
| | | 1 | 2 | 3 | 4 | 5 | 6 | 7 | 8 | 9 | 10 |
| Ni particles | Ni particles 1 | 4.0 | 4.0 | 4.0 | 4.0 | 4.0 | — | — | — | — | — |
| [part(s) by | Ni particles 2 | — | — | — | — | — | 4.0 | 4.0 | 4.0 | 4.0 | 4.0 |
| mass] | Ni particles 3 | — | — | — | — | — | — | — | — | — | — |
| Dispersant | Ammonium oleate | — | 4.0 | — | 1.2 | 1.2 | 1.2 | — | — | — | — |
| [part(s) by | Ammonium polyacrylate | — | — | 0.5 | — | — | — | — | — | — | — |
| mass] | Ammonium salt of | — | — | — | — | — | — | — | 1.0 | — | — |
| | acrylic acid/maleic | | | | | | | | | | |
| | acid copolymer | | | | | | | | | | |
| | Ammonium salt of | — | — | — | — | — | — | — | — | 1.0 | — |
| | acrylic acid/methyl | | | | | | | | | | |
| | methacrylate | | | | | | | | | | |
| | Ammonium salt of | — | — | — | — | — | — | — | — | — | 1.0 |
| | polyacrylic-styrene | | | | | | | | | | |
| | Sodium dodecyl sulfate | — | — | — | — | — | — | 10.0 | — | — | — |
| | Ammonium | — | — | — | 1.8 | 1.8 | 1.8 | — | — | — | — |
| | dodecylbenzenesulfonate | | | | | | | | | | |
| | Sodium stearate | — | — | — | — | — | — | 0.5 | — | — | — |
| | Polyvinylpyrrolidone | 0.5 | — | — | — | — | — | — | — | — | — |
| | K-30 | | | | | | | | | | |
| | ISOBAM 600 | — | — | — | — | — | — | — | — | — | — |
| | ISOBAM 110 | — | — | — | — | — | — | — | — | — | — |
| | Amount with respect | 13 | 100 | 13 | 75 | 75 | 75 | 263 | 25 | 25 | 25 |
| | to 100 parts by | | | | | | | | | | |
| | mass of Ni particles | | | | | | | | | | |
| First additive | Glycine | — | — | — | — | — | — | — | — | — | — |
| [part(s) by | Acetic acid | — | — | — | — | — | — | — | — | — | — |
| mass] | EDTA•2NH₄ | — | — | — | — | — | — | — | — | — | — |
| | Ammonium glutamate | — | — | — | — | — | — | — | — | — | — |
| Surfactant | Acetylene glycol E-100 | 0.5 | 0.5 | 0.5 | 0.5 | — | 0.5 | 0.5 | 0.5 | 0.5 | 0.5 |
| [part(s) by | Polyoxyethylene | — | — | — | — | 0.5 | — | — | — | — | — |
| mass] | lauryl ether | | | | | | | | | | |
| Water-soluble | Glycerin | 15.0 | 15.0 | 25.0 | — | 15.0 | 15.0 | 15.0 | 15.0 | 15.0 | 15.0 |
| organic solvent | Ethylene glycol | — | — | — | 11.0 | — | — | — | — | — | — |
| [part(s) by | Diethylene glycol | — | — | 20.0 | — | — | — | — | — | — | — |
| mass] | Ethylene glycol | — | — | — | — | — | — | — | — | — | — |
| | monobutyl ether | | | | | | | | | | |
| | Amount with respect | 19 | 20 | 90 | 13 | 19 | 19 | 21 | 19 | 19 | 19 |
| | to 100 parts by | | | | | | | | | | |
| | mass of water | | | | | | | | | | |
| Water | Water | 80.0 | 76.5 | 50.0 | 81.5 | 77.5 | 77.5 | 70.0 | 79.5 | 79.5 | 79.5 |
| [part(s) by | | | | | | | | | | | |
| mass] | | | | | | | | | | | |
| Average particle | D50 | 161 | 143 | 108 | 101 | 102 | 100 | 135 | 121 | 110 | 109 |
| diameter [nm] | D90 | 306 | 259 | 189 | 167 | 170 | 167 | 204 | 189 | 181 | 181 |
| Evaluation | Dispersion stability | B | B | A | A | A | A | A | A | A | A |
| result | Inkjet ejection | B | A | A | A | B | B | A | A | A | A |
| | stability | | | | | | | | | | |

TABLE 2

| | | Examples | | | | | | | | | |
|---|---|---|---|---|---|---|---|---|---|---|---|
| | | 11 | 12 | 13 | 14 | 15 | 16 | 17 | 18 | 19 | 20 |
| Ni particles | Ni particles 1 | 4.0 | 8.0 | — | — | — | 8.0 | 8.0 | 8.0 | — | 12.0 |
| [part(s) by | Ni particles 2 | — | — | 8.0 | 8.0 | 8.0 | — | — | — | 12.0 | — |
| mass] | Ni particles 3 | — | — | — | — | — | — | — | — | — | — |
| Dispersant | Ammonium oleate | 1.2 | — | — | — | — | — | — | 1.2 | — | — |
| [part(s) by | Ammonium polyacrylate | — | 1.0 | 0.8 | 0.8 | 1.0 | 1.0 | 1.0 | — | 1.5 | — |
| mass] | Ammonium salt of | — | — | — | — | — | — | — | — | — | 2.0 |
| | acrylic acid/maleic | | | | | | | | | | |
| | acid copolymer | | | | | | | | | | |
| | Ammonium salt of | — | — | — | — | — | — | — | — | — | — |
| | acrylic acid/methyl | | | | | | | | | | |
| | methacrylate | | | | | | | | | | |
| | Ammonium salt of | — | — | — | — | — | — | — | — | — | — |
| | polyacrylic-styrene | | | | | | | | | | |
| | Sodium dodecyl sulfate | — | — | — | — | — | — | — | — | — | — |
| | Ammonium | 1.5 | — | — | — | — | — | — | 1.8 | — | — |
| | dodecylbenzenesulfonate | | | | | | | | | | |
| | Sodium stearate | — | — | — | — | — | — | — | — | — | — |
| | Polyvinylpyrrolidone | — | — | — | — | — | — | — | — | — | — |
| | K-30 | | | | | | | | | | |
| | ISOBAM 600 | — | — | — | — | — | — | — | — | — | — |
| | ISOBAM 110 | — | — | — | — | — | — | — | — | — | — |
| | Amount with respect | 68 | 13 | 10 | 10 | 13 | 13 | 13 | 38 | 13 | 17 |
| | to 100 parts by | | | | | | | | | | |
| | mass of Ni particles | | | | | | | | | | |
| First additive | Glycine | — | — | 0.5 | 0.5 | — | — | — | 0.5 | 0.5 | 0.5 |
| [part(s) by | Acetic acid | — | — | — | — | 0.3 | — | — | — | 0.3 | — |
| mass] | EDTA•2NH₄ | — | — | — | — | — | 0.5 | — | — | — | — |
| | Ammonium glutamate | — | — | — | — | — | — | 0.5 | | — | — |
| Surfactant | Acetylene glycol E-100 | 0.5 | 0.5 | 0.5 | 0.5 | 0.5 | 0.5 | 0.5 | 0.5 | 0.5 | 0.5 |
| [part(s) by | Polyoxyethylene | — | — | — | — | — | — | — | — | — | — |
| mass] | lauryl ether | | | | | | | | | | |
| Water-soluble | Glycerin | 15.0 | 15.0 | 15.0 | 15.0 | 15.0 | 15.0 | 15.0 | 15.0 | 15.0 | 15.0 |
| organic solvent | Ethylene glycol | — | — | — | — | — | — | — | — | — | — |
| [part(s) by | Diethylene glycol | — | — | — | — | — | — | — | — | — | — |
| mass] | Ethylene glycol | — | — | — | — | — | — | — | — | — | — |
| | monobutyl ether | | | | | | | | | | |
| | Amount with respect | 19 | 20 | 20 | 20 | 20 | 20 | 20 | 21 | 21 | 21 |
| | to 100 parts by | | | | | | | | | | |
| | mass of water | | | | | | | | | | |
| Water | Water | 77.8 | 75.5 | 75.2 | 75.2 | 75.2 | 75.0 | 75.0 | 73.0 | 70.2 | 70.0 |
| [part(s) by | | | | | | | | | | | |
| mass] | | | | | | | | | | | |
| Average particle | D50 | 86.3 | 142 | 103 | 92.3 | 111 | 99.2 | 103 | 102 | 106 | 111 |
| diameter [nm] | D90 | 116 | 254 | 180 | 199 | 231 | 162 | 172 | 172 | 199 | 206 |
| Evaluation | Dispersion stability | A | B | A | A | A | A | A | A | A | A |
| result | Inkjet ejection | A | A | A | A | A | A | A | A | A | A |
| | stability | | | | | | | | | | |

TABLE 3

| | | Comparative Examples | | | | |
|---|---|---|---|---|---|---|
| | | 1 | | 3 | 4 | 5 |
| Ni particles | Ni particles 1 | 4.0 | 8.0 | 4.0 | — | — |
| [part(s) by | Ni particles 2 | — | — | — | — | — |
| mass] | Ni particles 3 | — | — | — | 8.0 | 8.0 |
| Dispersant | Ammonium oleate | 0.2 | — | — | — | — |
| [part(s) by | Ammonium polyacrylate | — | — | 15.0 | 2.0 | 2.0 |
| mass] | Ammonium salt of | — | — | — | — | — |
| | acrylic acid/maleic | | | | | |
| | acid copolymer | | | | | |
| | Ammonium salt of | — | — | — | — | — |
| | acrylic acid/methyl | | | | | |
| | methacrylate | | | | | |
| | Ammonium salt of | — | — | — | — | — |
| | polyacrylic-styrene | | | | | |
| | Sodium dodecyl sulfate | — | — | — | — | — |
| | Ammonium | — | — | — | — | — |
| | dodecylbenzenesulfonate | | | | | |
| | Sodium stearate | — | — | — | — | — |
| | Polyvinylpyrrolidone | — | — | — | — | — |
| | K-30 | | | | | |
| | ISOBAM 600 | — | 0.3 | — | — | — |
| | ISOBAM 110 | — | 0.08 | — | — | — |
| | Amount with respect | 5 | 4.75 | 375 | 25 | 25 |
| | to 100 parts by | | | | | |
| | mass of Ni particles | | | | | |
| First additive | Glycine | — | — | — | 0.5 | 0.5 |
| [part(s) by | Acetic acid | — | — | — | — | — |
| mass] | EDTA•2NH₄ | — | — | — | — | — |
| | Ammonium glutamate | — | — | — | — | — |
| Surfactant | Acetylene glycol E-100 | 0.5 | 0.5 | 0.5 | 0.5 | 0.5 |
| [part(s) by | Polyoxyethylene | — | — | — | — | — |
| mass] | lauryl ether | | | | | |
| Water-soluble | Glycerin | 15.0 | 15.0 | 15.0 | 5.0 | 8.0 |
| organic solvent | Ethylene glycol | — | — | — | — | — |
| [part(s) by | Diethylene glycol | — | — | — | — | — |
| mass] | Ethylene glycol | — | — | — | 70.0 | — |
| | monobutyl ether | | | | | |
| | Amount with respect | 19 | 20 | 23 | 536 | 10 |
| | to 100 parts by | | | | | |
| | mass of water | | | | | |
| Water | Water | 80.3 | 76.1 | 65.5 | 14.0 | 81.0 |
| [part(s) by | | | | | | |
| mass] | | | | | | |
| Average particle | D50 | 630 | Thickening | Thickening | 103 | 99 |
| diameter [nm] | D90 | >2,000 | — | — | 187 | 191 |
| Evaluation | Dispersion stability | C | C | C | B | B |
| result | Inkjet ejection | — | — | — | C | C |
| | stability | | | | | |

### Example 21

A plate-shaped modeled article having dimensions of 21 mm×7 mm×0.7 mm was manufactured through use of the apparatus illustrated in the FIGURE and the ink produced in Example 14.

Step (1)

As metal powder, SUS316L, (average particle diameter: II um, manufactured by Sanyo Special Steel Co., Ltd.) particles were used. Metal powder layers were laminated with a thickness of 100 μm per layer.

### Step (2)

The ink produced in Example 14 was applied to a modeling region through use of a piezoelectric head KJ4B (manufactured by Kyocera Corporation). For application of each layer, heating was performed so that the surface layer reached 60° C.

### Step (3)

After all the, ten layers were laminated, a liquid content was dried. Then, the laminate was heated at 650° C. for 1 hour under a nitrogen atmosphere, to thereby sinter the nickel particles in the ink.

### Step (4)

The SUS316L particles in a region other than the modeling region were removed from the obtained laminate to obtain a modeled article having dimensions of 30 mm×10 mm×1 mm Further, the obtained modeled article was heated at 1,350° C. for 1 hour under vacuum to obtain a modeled article having dimensions of 21 mm×7 mm×0.7 mm

The obtained modeled article had a tensile strength of 500 MPa, which was more than the tensile strength of 480 MPa specified for SUS316L under JIS Standards.

While the present disclosure has been described with reference to exemplary embodiments, it is to be understood that the present disclosure is not limited to the exemplary embodiments. The scope of the following claims is to be accorded the broadest interpretation so as to encompass all such modifications and equivalent structures and functions.

This application claims the benefit of Japanese Patent Application No. 2019-086465, filed Apr. 26, 2019, which is hereby incorporated by reference herein in its entirety.

What is claimed is:

1. An inkjet ink comprising:
nickel particles;
a dispersant;
a nonionic surfactant; and
a mixed solvent of water and a water-soluble organic solvent,
wherein the inkjet ink contains the dispersant in an amount of 10 parts by mass or more and 100 parts by mass or less with respect to 100 parts by mass of the nickel particles, and
wherein the inkjet ink contains the water-soluble organic solvent in an amount of 11 parts by mass or more and 100 parts by mass or less with respect to 100 parts by mass of the water.

2. The inkjet ink according to claim 1, wherein the nickel particles have an average particle diameter D50 of 10 nm or more and 150 nm or less, which is measured by a dynamic light scattering method, and the nickel particles have an average particle diameter D90 of 250 nm or less, which is measured by the dynamic light scattering method.

3. The inkjet ink according to claim 1, wherein the dispersant contains at least any one member selected from the group consisting of a fatty acid, an alkyl benzene sulfonic acid, an alkyl sulfuric acid, a polycarboxylic acid, and salts thereof.

4. The inkjet ink according to claim 1, wherein the water-soluble organic solvent contains at least any one member selected from the group consisting of glycerin, diglycerin, ethylene glycol, diethylene glycol, triethylene glycol, tetraethylene glycol, propylene glycol, 2-pyrrolidone, N-methylpyrrolidone, polyethylene glycol having a molecular weight of 800 or less, 1,3 ₗ ropanediol, and 1,4-butanediol.

5. The inkjet ink according to claim 1, further comprising at least any one member selected from the group consisting of acetic acid, glycine, aspartic acid, glutamic acid, citric acid, ethylenediaminetetraacetic acid, oxalic acid, and salts thereof.

6. The inkjet ink according to claim 1, wherein the nonionic surfactant is a compound represented by the following formula (1): 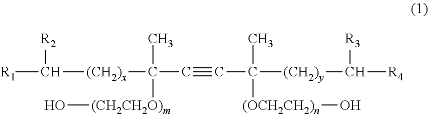
in the formula (1), R₁ to R₄ each independently represent an alkyl group having 1 to 3 carbon atoms, x and y each independently represent from 1 to 5, and m+n represents from 0 to 20.

7. An ink cartridge comprising an inkjet ink,
wherein the inkjet ink contains nickel particles, a dispersant, a nonionic surfactant, and a mixed solvent of water and a water-soluble organic solvent,
wherein the inkjet ink contains the dispersant in an amount of 10 parts by mass or more and 100 parts by mass or less with respect to 100 parts by mass of the nickel particles, and
wherein the inkjet ink contains the water-soluble organic solvent in an amount of 11 parts by mass or more and 100 parts by mass or less with respect to 100 parts by mass of the water.

8. A three-dimensional modeling method comprising performing modeling by repeating, a plurality of times:
forming a metal powder layer; and
applying an inkjet ink to the metal powder layer based on slice data on an object to be modeled which has been acquired in advance, to thereby laminate the metal powder layers on one another,
wherein the inkjet ink contains nickel particles, a dispersant, a nonionic surfactant, and a mixed solvent of water and a water-soluble organic solvent,
wherein the inkjet ink contains the dispersant in an amount of 10 parts by mass or more and 100 parts by mass or less with respect to 100 parts by mass of the nickel particles, and
wherein the inkjet ink contains the water-soluble organic solvent in an amount of 11 parts by mass or more and 100 parts by mass or less with respect to 100 parts by mass of the water.

9. The three-dimensional modeling method according to claim 8, further comprising collectively heating the laminated metal powder layers at a temperature that is equal to or higher than a temperature at which the nickel particles contained in the inkjet ink are melted or sintered, and that is lower than a temperature at which the metal powder is sintered.

10. The three-dimensional modeling method according to claim 9, further comprising taking out a modeled article from the metal powder layers after being heated and heating the modeled article at a temperature equal to or higher than a temperature at which the metal powder is melted or sintered.
